(19) United States
(12) Patent Application Publication
(10) Pub. No.: US 2006/0000593 A1
(43) Pub. Date: Jan. 5, 2006

(54) Device and method for climate control of an interior space, especially the interior of a vehicle

(75) Inventors: Patric Schlecht, Ostfildern (DE); Alfons Schaefer, Altbach (DE); Alfred Elbert, Remseck (DE)

Correspondence Address: DAVIDSON, DAVIDSON & KAPPEL, LLC, 485 SEVENTH AVENUE, 14TH FLOOR, NEW YORK, NY, 10018, US

(73) Assignees: Behr GmbH & Co. KG, Stuttgart (DE); J. Eberspaecher GmbH & Co. KG, Esslingen (DE)

(21) Appl. No.: 11/159,446

(22) Filed: Jun. 23, 2005

(30) Foreign Application Priority Data
Jun. 24, 2004 (DE) DE 10 2004 030 68

(51) Int. Cl. B60H 3/00; B60H 1/00; B61D 27/00; F25B 29/00

(52) U.S. Cl. 165/202; 165/262; 165/43; 165/51

(57) ABSTRACT

A device for climate control of an interior space includes comprising a heating and/or air-conditioning device fitted with a flow channel for an air current that is to be conditioned. On the inlet side there is an evaporator in the flow channel, and there is a first heat exchanger and a second heat exchanger in the flow channel downstream from said evaporator. The first heat exchanger is configured as a fuel-powered air-air heat exchanger. In addition, a method for climate control of an interior space using the heating and/or air-conditioning device.

Priority is claimed to German Patent Application No. DE 10 2004 030 681.8, filed on Jun. 24, 2004, the entire disclosure of which is incorporated by reference herein.

The present invention relates to a device and to a method for climate control of an interior space, especially the interior of a vehicle.

### BACKGROUND

Such a device for climate control of an interior space is employed especially in vehicles. The device for climate control normally comprises a heating and/or air-conditioning device (also referred to as conditioning system or HVAC system, which stands for heating, ventilation and air-conditioning) fitted with a flow channel for conditioning an air current that moves through the flow channel. For climate-control purposes, the heating and/or air-conditioning device has an evaporator installed in a coolant circulation system and a heat exchanger as well as, optionally, a heater. The coolant flow is normally generated by a compressor installed in the coolant circulation system, said compressor being directly driven by the vehicle engine. Therefore, the coolant flow subsides as soon as the vehicle engine is turned off.

Generally speaking, an auxiliary heater is needed in order to pre-heat the vehicle interior or to warm up the engine ahead of time when the vehicle engine is not running. Such an auxiliary heater can be, for instance, a fuel-powered air-water heat exchanger through which combustion air heated up by a combustion chamber flows at a programmed time or in response to a signal emitted, for example, by a remote control unit, so that the water, especially the cooling water of an engine, is warmed up. The cooling water is then continuously circulated through the engine and through the heat exchanger of the auxiliary heater. Moreover, a conventional heat exchanger of the type used in heating systems (=water-air heat exchanger) then transfers the heat in the engine cooling circulation system to the air flowing into the interior of the vehicle, whereby the air that passes through the heat exchanger, for example, fresh air or circulated air, is heated up and fed into the interior of the vehicle. Frequently, the auxiliary heater is configured separately, so that it can be installed in a vehicle at a later point in time. In the case of commercial vehicles, air heating systems are usually built in.

### SUMMARY OF THE INVENTION

The invention is based on the objective of creating a device and a method for climate control of an interior space which allow sufficient and simple climate control of the interior while a vehicle is being driven as well as when it is not running.

The present invention provides a device for climate control of an interior space that includes a heating and/or air-conditioning device fitted with a flow channel for an air current that is to be conditioned. On the inlet side, there is an evaporator in the flow channel, and there is a first heat exchanger and a second heat exchanger in the flow channel downstream from the evaporator, whereby the first heat exchanger is configured as a fuel-powered air-air heat exchanger.

In addition, the present invention provides a method for climate control of an interior space using a heating and/or air-conditioning device fitted with a flow channel for an air current to be conditioned. According to the method, said air current is fed in the flow channel through an evaporator and heated up by a first heat exchanger that is configured as a fuel-operated air-air heat exchanger and that is located downstream from the evaporator in the flow channel. Subsequently the air current is fed directly into the interior space and/or indirectly into the interior space at least partially through a second heat exchanger located downstream from the first heat exchanger.

Thus, for purposes of proper climate control in an interior space, for example, the interior of a vehicle, when the vehicle is being driven as well as when the vehicle is not running, that is to say, when the engine is switched off, it should be possible to optimize pre-heating or warming up of the interior while simultaneously attaining good pre-warming or cooling of the engine. In this context, the possibility should exist to choose the modality of the pre-heating, namely, pre-heating of the interior of the vehicle and/or pre-warming of the engine. For this purpose, a combined arrangement of two heat exchangers in a heating and/or air-conditioning system is provided, thus ensuring various modes of operation for heating and cooling. In particular, the device for climate control in the interior comprises a heating and/or air-conditioning device with a flow channel for an air current that is to be conditioned whereby there is an evaporator in the flow channel on the inlet side, and there is a first heat exchanger and a second heat exchanger in the flow channel downstream from said evaporator, whereby the first heat exchanger is configured as a fuel-powered air-air heat exchanger. The term air-air heat exchanger refers especially to a heat exchanger that essentially transfers heat from hot combustion gases to the air current that is to be conditioned. Preferably, the second heat exchanger is configured as a water-air heat exchanger. With a water-air heat exchanger, for instance, the heat present in the engine cooling circulation system is transferred to the air current that is to be conditioned. For this purpose, the second heat exchanger is advantageously arranged in the coolant circulation system or in the engine cooling circulation system of a combustion engine.

Such a combination of two heat exchangers—a first, fuel-powered air-air heat exchanger and a second, water-air heat exchanger—makes it possible to heat up and control the temperature in the interior of a vehicle while simultaneously pre-warming the engine, for example, when the vehicle is cold started and the engine is then running. When the interior of the vehicle and the engine are being heated up simultaneously, the available heat streams are less, so that the warm-up or pre-heating takes correspondingly longer. Moreover, the pre-warming of the engine and the heating up of the vehicle interior can be regulated by a timer. The vehicle interior can also be heated up very quickly, even when the engine is not running.

Depending on the requirements, fresh air and/or circulated air can pass through the flow channel of the heating and/or air-conditioning device. For this purpose, a first air current regulator is advantageously arranged on the inlet side in the flow channel upstream from the evaporator so that fresh air and/or circulated air can be fed in. The first air current regulator is configured, for example, as a mixing or swing flap.

A second air current regulator is preferably arranged between the first heat exchanger and the second heat exchanger so that the air throughput rate on the second heat exchanger can be adjusted individually. The term air throughput rate is defined as the volume of air that flows through a given flow cross section per unit of time. For instance, the second air current regulator can be set between a first end position that closes the flow channel in the direction of the second heat exchanger, and a second end position that opens up the flow channel in the direction of the second heat exchanger, as well as in any desired position in-between.

In a first operating state (=built-in heating operation, the vehicle engine is running), in order to heat up the air current, that is to say, the fresh air and/or circulated air, the air can be passed through the first heat exchanger and at least partially or completely through the second heat exchanger. Here, as a function of a prescribed temperature and the resultant position of the second air current regulator, the air current (fresh air and/or circulated air) heated up by the first heat exchanger is at least partially heated up additionally by the second heat exchanger. In other words, if the air current has not yet been sufficiently heated up, it can be fed into the vehicle interior indirectly, at least partially, via the second heat exchanger in order to be additionally heated up, and otherwise the air current is fed directly into the vehicle interior.

In a practical manner, the second air current regulator can be controlled and/or regulated as a function of a prescribed temperature and/or a prescribed time. For instance, the second current regulator can be controlled and/or regulated as a function of the interior temperature and/or of the return temperature in the coolant circulation system.

In addition, in an expanded operating mode when the engine is running, especially in the case of a cold start or in order to attain sufficient engine heat, the air current heated up by the first heat exchanger can be used for pre-warming the engine by means of the second heat exchanger arranged in the coolant circulation system. For this purpose, a conventional water pump driven by the vehicle engine is advantageously integrated into the coolant circulation system, so that the amount of heat present in the air current after passing through the first heat exchanger is transferred to the now operating coolant circulation system and the heated up air current can be used as soon as possible to heat up the interior of the vehicle. Alternatively, if the engine is switched off and the auxiliary heater is already switched on, an electric water pump additionally integrated into the coolant circulation system can be employed to heat up the cooling water of the vehicle engine. Here, the electric water pump is powered by the vehicle's own onboard network. Moreover, the electric water pump can also be regulated as a function of the time and/or of the temperature. Additionally, in this mode of operation of the cold start, the interior of the vehicle continues to be heated up after the auxiliary heater has been turned on.

In a second mode of operation (=auxiliary heater, vehicle engine is switched off), the air current heated up by the first heat exchanger can be fed directly into the interior of the vehicle. In other words, the heated up air current is completely used to pre-heat the vehicle interior, so that the fastest possible warm-up is ensured.

So as to allow an individual setting of the various operating modes and states, the heating output of the first heat exchanger can be regulated as a function of a prescribed temperature, especially the return temperature in the coolant circulation system and/or as a function of the temperature in the interior. In other words, depending on the requirement, e.g. only pre-heating of the interior (=auxiliary heater) or combined pre-heating of the interior and pre-warming of the engine, only the interior temperature or else the interior temperature as well as the return temperature are employed to control and/or regulate the heating output of the first heat exchanger and/or of the second heat exchanger in that the position of the second current regulator can be appropriately regulated, or else in that the air current volume that is fed by a fan located upstream from the evaporator can be adjusted. In order to set up another mode of operation, there preferably is an additional third air current regulator in the form of a bypass flap installed on the outlet side of the first heat exchanger, as a result of which the conditioned air current bypasses the first heat exchanger and can be fed directly or indirectly into the interior of the vehicle through the position of the second air current regulator.

Advantageously, the heating and/or air-conditioning device with the evaporator and the first heat exchanger as well as the second heat exchanger is configured as an integrated modular unit (also referred to as an air-conditioning system with an integrated auxiliary heater). In particular, these modular units are arranged in a shared housing and can thus be produced and mounted as a single module.

Regarding the method for climate control of the interior of a vehicle using the heating and/or air-conditioning device with the flow channel for an air current that is to be conditioned, said air current in the flow channel is fed through an evaporator and heated up by a first heat exchanger that is configured as a fuel-operated air-air heat exchanger and that is located downstream from the evaporator in the flow channel, whereby the air current is subsequently fed directly into the interior of the vehicle and/or indirectly into the interior of the vehicle at least partially through a second heat exchanger located downstream from the first heat exchanger. Here, a fan blows fresh air and/or circulated air as the air current into the flow channel on the inlet side.

Depending on the operating state of the heating and/or air-conditioning device, in a first operating state (=built-in heating operation), in order to heat up the air current, the latter is fed through the first heat exchanger and at least partially or else completely through the second heat exchanger. As an alternative, in a second operating state (=auxiliary heater), the air current heated up in the first heat exchanger can be fed directly into the interior of the vehicle. In another operating state (cooling operation), the conditioned air current preferably bypasses the first heat exchanger and is subsequently fed at least partially or else completely to the second heat exchanger. It is also possible for the conditioned air to bypass the second heat exchanger as well and to be fed directly into the interior of the vehicle.

For individual climate control in the interior of the vehicle and/or for pre-warming the engine as a function of the vehicle operation, the air current volume that is to be fed through the second heat exchanger is regulated as a function of the interior temperature and/or of the return temperature in the coolant circulation system. Moreover, an electric water pump arranged in the coolant circulation system can be controlled as a function of the time and/or of the temperature. Furthermore, the heating output of the first heat exchanger can be regulated as a function of a prescribed temperature, particularly the return temperature in the coolant circulation system and/or as a function of the temperature in the interior of the vehicle.

Advantages attained with the invention include the fact that, by means of a combined arrangement with a fuel-powered, first air-air heat exchanger and a second heat exchanger that is arranged especially in the coolant circulation system, it is possible to individually control the temperature in the interior of the vehicle as well as, at the same time, to individually pre-heat the engine when the car is not running and also when it is being driven. Thus, the engine can be pre-heated and the temperature in the interior of the vehicle can be controlled by means of an electric water pump, for instance, during a cold start. As an alternative, in order to achieve a rapid warm-up of the interior of the vehicle, the air heated by the first heat exchanger, which functions as an auxiliary heater, can be fed completely into the interior of the vehicle. In another embodiment, the engine can be pre-heated and/or the vehicle interior can be climate-controlled ahead of time as a function of the time and/or of the temperature.

### BRIEF DESCRIPTION OF THE DRAWINGS

Embodiments of the invention will be explained in greater depth below with reference to a drawings, in which:

FIG. 1 shows a schematic depiction of a device for climate control of an interior space, with an integrated auxiliary heater; and

FIG. 2 shows a cross sectional view of a device for climate control of an interior space, with an integrated auxiliary heater.

### DETAILED DESCRIPTION

Corresponding parts are provided with the same reference numerals in all of the figures.

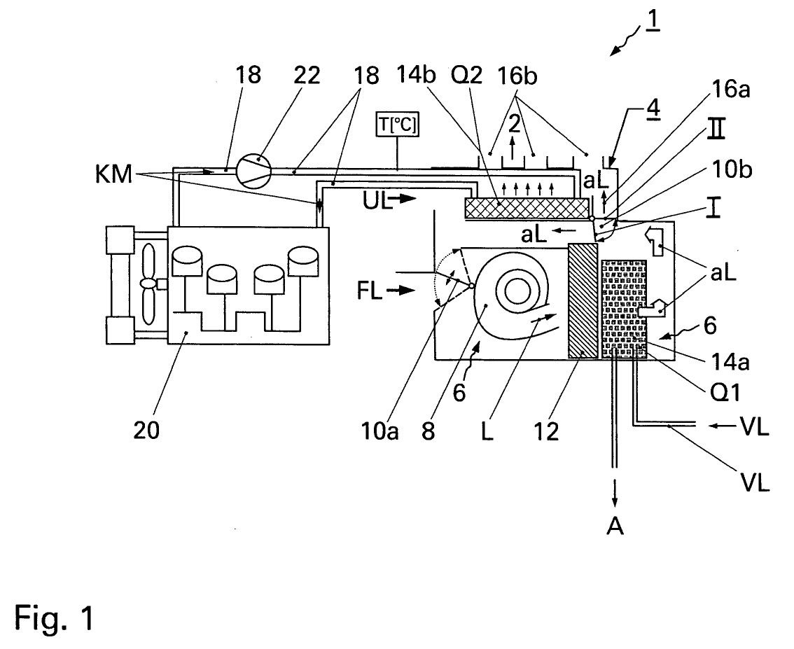

FIG. 1 shows a device 1 for climate control of an interior space 2, for example, the interior of a vehicle. The device 1 comprises a heating and/or air-conditioning device 4 (also referred to as an HVAC module, wherein HVAC stands for heating, ventilation and air-conditioning).

The heating and/or air-conditioning device 4 (hereinafter referred to as conditioning system 4) comprises a flow channel 6 for feeding an air current L that is to be conditioned. A fan 8 that serves to blow the air current L is arranged in the flow channel 6 on the inlet side. Depending on the requirements, an appropriate setting of a first air current regulator 10a can be employed for feeding fresh air FL and/or circulated air UL as the air current L by means of the fan 8.

Subsequently, the air current L in the flow channel 6 is fed to an evaporator 12 in order to cool the air to below the ambient temperature. The cooled air current L is fed, at least partially, to a first heat exchanger 14a that effectuates a first temperature control of the air current L.

The first heat exchanger 14a is configured as a fuel-powered air-air heat exchanger. Here, the combustion air VL is fed into a combustion chamber (not shown here), where it is burned, as a result of which the air current L fed through the first heat exchanger 14a is heated up indirectly by the hot exhaust gases A. For climate control, the heated-up air current aL in the flow channel 6 is fed directly via an air outlet 16a into the interior space 2 and/or indirectly via a second heat exchanger 14b and air outlets 16b located downstream.

In order to regulate the partially heated-up air current aL via the second heat exchanger 14b, a second air current regulator 10b is arranged between the first heat exchanger 14a and the second heat exchanger 14b. The air current regulator 10b is configured, for instance, as a mixing or swing flap or else as a temperature mixing flap (mixing flap with a temperature-dependent control).

Moreover, the second heat exchanger 14b is arranged in the coolant circulation system 18—a water circulation system—of the vehicle engine 20. Here, a coolant KM is fed by means of a pump 22, for example, an electrically operated water pump, in the so-called water-circulation return, to the second heat exchanger 14b, which is configured as a water-air heat exchanger, and then returned to the vehicle engine 20 in the so-called water-circulation feed, in order to pre-heat the vehicle engine 20. An appropriate setting of the pump 22 ensures that the coolant KM flows through the coolant circulation system 18.

The combined arrangement of the first heat exchanger 14a and the second heat exchanger 14b with the second air current regulator 10b arranged between them makes it possible to set different heating and cooling operating states when operating the device 1 for climate control in the interior space 2, and these operating states will be described in greater detail below.

In a first operating state, for example, in the built-in heating operation for warming up the vehicle engine 20 and for controlling the temperature in the interior 2, particularly in the case of a cold start, the fresh air L is fed through the first heat exchanger 14a and at least partially or completely through the second heat exchanger 14b. For this purpose, the second air current regulator 10b can be set between a first end position I that closes the flow channel 6 in the direction of the second heat exchanger 14b, and a second end position II that opens up the flow channel in the direction of the second heat exchanger 14b, or else in any desired position in-between. To describe this in detail, during the heating-up or built-in heating operation, fresh air FL is fed by means of the fan 8 so that it undergoes a first heating up by the fuel-powered first heat exchanger 14a at an appertaining first heating output Q1.

As a function of a temperature, for example, the interior temperature or the return temperature in the coolant circulation system or the temperature of the warmed-up or heated-up air aL, this air can be fed by means of the second air current regulator 10b, for instance, a mixing flap, downstream from the first heat exchanger 14a, through the second heat exchanger 14b, for instance, a water-air heat exchanger or water-air heater. Here, the heated-up air aL is additionally heated by the second heat exchanger 14b at an appertaining second heating output Q2. The air aL, which had already been warmed-up in the first heat exchanger 14a due to the first heating output Q1, influences the heat-emission characteristics of the second heat exchanger 14b and its heat emission or heating output Q2. In particular, the requisite amount of the second heating output Q2 is reduced by the already warmed-up air aL. This effect has an advantageous impact on the warm-up of the engine, since the heat energy that has not been carried off is made available to the vehicle engine 20. This means that, when the device 1 is operated with the auxiliary heater turned on and thus with the first heat exchanger 14a switched on, the engine can be warmed up more quickly while also providing the same amount or even more heat to the vehicle interior 2. By changing the position of the second air current regulator 10b into any desired intermediate position, the warm-up behavior in the interior 2 or in the vehicle engine 20 can be correspondingly influenced. Moreover, it is possible to control or regulate the heating output Q1 and/or Q2 of the first heat exchanger 14a or of the second heat exchanger 14b, respectively, as a function of the return temperature in the coolant circulation system 18 and/or of the interior temperature.

As an alternative, when the auxiliary heater has not been turned on ahead of time in the case of a cold start, the warmed-up air aL can be fed directly as well as indirectly into the interior space 2 so as to quickly heat up the interior of the vehicle. In this embodiment, the engine is warmed up via the conventional circulating pump that is part of the engine or powered by it (not shown here) and that is likewise integrated into the coolant circulation system 18.

In a second operating state, for instance, with the auxiliary heater and thus with the vehicle engine switched off, the position of the second air current regulator 10b at the end position I causes the air aL that was warmed-up by the auxiliary heater or by the first heat exchanger 14a to be fed directly into the interior 2 in order to heat up the interior of the vehicle. By feeding air directly into the interior 2 via the air outlet 16a, the interior space 2 can be heated up particularly quickly since no lost mass has to be warmed up.

In another operating state, for example, engine pre-heating, the pump 22, for instance, an electric water pump, is operated in the coolant circulation system 18. The fan 8 is set at a medium fan setting in order to blow a medium air current L. The second air current regulator 10b is in position II. The now circulating coolant stream, particularly a water stream, in the coolant circulation system 18, transfers the heating output Q1 of the first heat exchanger 14a to the second heat exchanger 14b in the form of heat transfer to the coolant KM of the coolant circulation system 18. The residual heat that has not been carried off is used to warm up the air current aL, which is subsequently fed into the interior space 2 via the air outlets 16b.

In other operating states, for instance, time-controlled engine pre-warming with heating of the passenger compartment or interior, or else temperature-controlled engine pre-warming with interior heating, the pump 22 is controlled as function of the time. For instance, if the vehicle engine is not running, a desired departure time can be stored by means of a control element of the auxiliary heater. If the engine is not running, the interior 2 is heated continuously or else cyclically or in a time-controlled manner; starting at a certain point in time, for example, two hours prior to departure, the pump 22 is additionally put into operation. As a function of the interior temperature, the first heating output Q1, which is not needed to heat the interior, can then be transferred to the coolant KM of the coolant circulation system 18 in order to pre-heat the engine. For this purpose, the burner output of the combustion chamber of the first heat exchanger 14a is raised to a maximum output and, at the same time, the position of the second air current regulator 10b is set in such a way that the interior temperature does not drop.

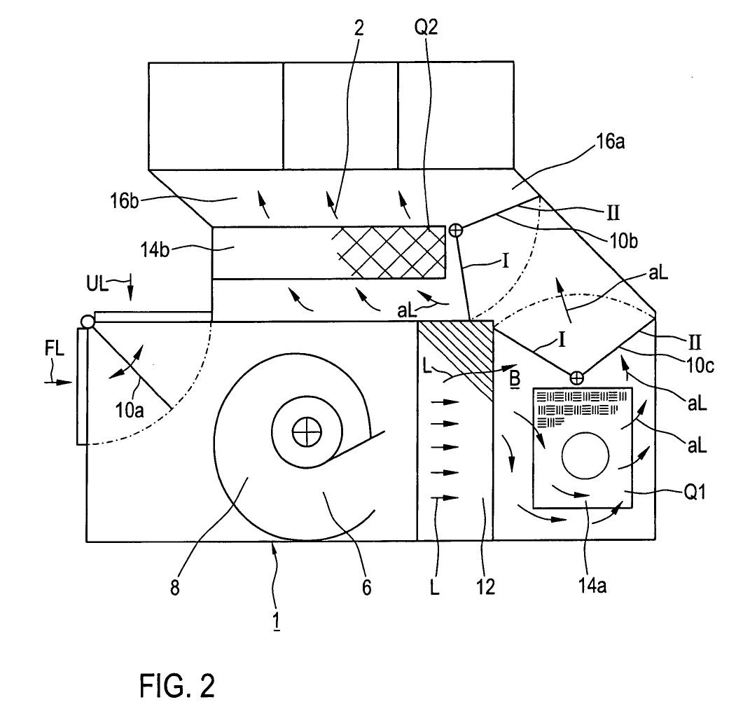

FIG. 2 shows a device 1 for climate control in an interior space 2, as a manufactured module with an integrated auxiliary heater. Here, the fan 8, for instance, a vehicle fan, draws in circulated air UL or fresh air FL and feeds it via the flow channel 6 to the evaporator 12 in order to cool off the air current L that is present in the flow channel 6 and that is to be conditioned to below the ambient temperature. Subsequently, the resultant cooled air current L can be fed to the first heat exchanger 14a in order to heat up the cooled-off air current L. In this mode of operation (=“OPEN”, built-in heating operation), the first heat exchanger 14a with the first heating output Q1 uses hot exhaust gases A to indirectly heat up the cooled-off air current L as it flows through the first heat exchanger 14a.

Depending on the prescribed mode of operation and on the setting of the climate control for the interior space 2, as an alternative to the “built-in heating operation”, in another mode of operation, namely, “cooling operation”, the conditioned air current L bypasses the first heat exchanger 14a via a bypass B. For this purpose, there is an additional third air current regulator 10c on the outlet side of the first heat exchanger 14a. Here, the third air current regulator 10c is configured, for example, as a swing flap, as a bypass flap that can be swung between a first end position I (=“OPEN” operating mode, that is to say, built-in heating operation) and a second end position II (=“CLOSED” operating mode, that is to say, cooling operation). In the first end position I, the conditioned air L passes through the first heat exchanger 14a (also referred to as the exhaust gas heat exchanger) as well as—depending on the position of the second air current regulator 10b located downstream (=temperature mixing flap)—through the second heat exchanger 14b (also referred to as a water heating element) and is correspondingly heated up and subsequently fed into the interior 2. In the second end position II, the conditioned air L bypasses the first heat exchanger 14a and, in turn, as a function of the position of the second air current regulator 10b, is fed directly and/or indirectly into the interior 2 via the second heat exchanger 14b.

As described above, the second air current regulator 10b is configured as a temperature mixing flap that can be set in any desired position between a first end position I (=auxiliary heater with heating of the conditioned air L by the exhaust gas heat exchanger 14a or else cooling operation whereby the conditioned air L bypasses the exhaust gas heat exchanger 14a) and a second end position II (=built-in heating operation with heating of the conditioned air L by the exhaust gas heat exchanger 14a and by the water heating unit 14b), thus serving to mix the differently heated air aL and/or conditioned air L on the inlet side of the interior 2. In other words, the combination of the second and third air current regulators 10b, 10c makes it possible to feed conditioned air L or heated-up air aL directly into the interior 2 at the outlet of the first heat exchanger 14a directly via the air outlet 16a and/or indirectly via the second heat exchanger 14b located downstream and via the air outlets 16b.

1. A device for climate control of an interior space, comprising:
a heating and/or air-conditioning device including a flow channel for an air current that is to be conditioned having an inlet side;
an evaporator disposed in the flow channel at the inlet side;
a first heat exchanger and a second heat exchanger disposed in the flow channel downstream from the evaporator, wherein the first heat exchanger is configured as a fuel-powered air-air heat exchanger.

2. The device as recited in claim 1, wherein the second heat exchanger is configured as a water-air heat exchanger.

3. The device as recited in claim 1, wherein the second heat exchanger is disposed in a coolant circulation system of a vehicle engine.

4. The device as recited in claims 1, further comprising a first air current regulator disposed at the inlet side in the flow channel upstream from the evaporator so as to enable the air current to be fed in.

5. The device as recited in claims 1, further comprising a second air current regulator disposed between the first heat exchanger and the second heat exchanger.

6. The device as recited in claim 5, wherein the second air current regulator is adjustable between a first end position that closes the flow channel in a direction of the second heat exchanger, and a second end position that opens the flow channel in a direction of the second heat exchanger, as well as to a third desired position between the first end position and the second end position.

7. The device as recited in claim 1, wherein, in a first operating state, the air current is passed through the first heat exchanger and at least partially through the second heat exchanger so as to heat the air current

8. The device as recited in claim 1, wherein, in a second mode of operation, the air current heated by the first heat exchanger is fed directly into the interior space.

9. The device as recited in claim 6, wherein the second air current regulator is controllable as a function of at least one of a prescribed temperature and a prescribed time.

10. The device as recited in claim 9, wherein the prescribed temperature includes at least one of an interior temperature and a return temperature in a coolant circulation system.

11. The device as recited in claim 10, wherein, the air current heated by the first heat exchanger is at least partially additionally heated by the second heat exchanger as a function of the prescribed temperature and a resultant position of the second air current regulator.

12. The device as recited in claim 11, further comprising a third air current regulator disposed on an outlet side of the first heat exchanger as a bypass flap for feeding a conditioned air current past the first heat exchanger directly or indirectly into the interior space.

13. The device as recited in claim 3, wherein the air current heated by the first heat exchanger is used for pre-warming the engine using the second heat exchanger disposed in the coolant circulation system.

14. The device as recited in claim 3, further comprising a pump controllable as a function of at least one of a time and a temperature integrated into the coolant circulation system.

15. The device as recited in claim 1, wherein the first heat exchanger includes a first heating output controllable as a function of a prescribed temperature.

16. The device as recited in claim 3, wherein the prescribed temperature is one of a return temperature in the coolant circulation system and an interior temperature.

17. The device as recited in claim 1, wherein the heating and/or air-conditioning device, the evaporator, the first heat exchanger and the second heat exchanger are integrated in a modular unit.

18. A method for climate control of an interior space, the method comprising:
providing a heating and/or air-conditioning device fitted with a flow channel for an air current to be conditioned;
feeding the air current into the flow channel and through an evaporator;
heating the air current using a first heat exchanger configured as a fuel-operated air-air heat exchanger and disposed downstream from the evaporator in the flow channel; and
feeding the air current into the interior space, wherein the feeding of the air current into the interior space is performed in one of a direct manner and an indirect manner at least partially passing through a second heat exchanger disposed downstream from the first heat exchanger.

19. The method as recited in claim 18, wherein the air current to be conditioned includes at least one of circulated air and fresh air, and wherein the feeding includes blowing the air current into the flow channel at the inlet side using a fan.

20. The method as recited in claim 18, further comprising feeding the air current through the first heat exchanger and at least partially through a second heat exchanger so as to heat up the air current in a first operating state.

21. The method as recited in claim 20, further comprising regulating a volume of the air current to be fed through the second heat exchanger as a function of at least one of a prescribed temperature and a prescribed time.

22. The method as recited in claim 20, further comprising regulating a volume of the air current to be fed through the second heat exchanger as a function of at least one of a temperature of the interior and a return temperature in a coolant circulation system.

23. The method as recited in claim 21, further comprising heating the air current using the first heat exchanger so as to pre-warm an engine using the second heat exchanger disposed in a coolant circulation system.

24. The method as recited in claim 23, further comprising controlling a pump disposed in the coolant circulation system as a function of at least one of a time and a temperature.

25. The method as recited in claim 18, further comprising feeding the air current from the first heat exchanger directly into the interior space in a second operating state.

26. The method as recited in claim 18, further comprising controlling a heating output of the first heat exchanger as a function of at least one of a prescribed temperature.

27. The method as recited in claim 26, wherein the prescribed temperature is at least one of a temperature of the interior and a return temperature in a coolant circulation system.

28. The method as recited in claim 27, further comprising bypassing the conditioned air current around the first heat exchanger using a bypass.
